(19) United States
(12) Patent Application Publication
(10) Pub. No.: US 2007/0013241 A1
(43) Pub. Date: Jan. 18, 2007

(54) Lamination stack cooling path

(76) Inventors: Rich F. Schiferl, Chagrin Fall, OH (US); Michael J. Melfi, Euclid, OH (US); Qimin J. Dong, Greer, SC (US)

Correspondence Address: Susan Donahue;Allen-Bradley Company, L.L.C., Patent Dept., 704P Floor 8 T-29, 1201 South Second Street, Milwaukee, WI, 53204-2496, US

(21) Appl. No.: 11/180,255

(22) Filed: Jul. 13, 2005

(51) Int. Cl. H02K 9/20; H02K 9/00

(52) U.S. Cl. 310/54; 310/58

(57) ABSTRACT

According to one embodiment, the present invention provides a motor having a stator core disposed in a motor frame. The stator core is formed of a plurality of substantially identical laminations. Each lamination of the stator core comprises at least one recessed section, which, in cooperation with the frame, defines an incremental segment of closed passageway for routing a fluid along a perimetric surface of the stator core. Accordingly, the closed passageway provides a mechanism by which the outer regions of the stator core may be more effectively cooled. Furthermore, the laminations of the stator core may be oriented at varied orientations with respect to one another to form a labyrinthine path along the surface of the stator core through which coolant is routed.

### BACKGROUND

The present technique relates generally to the field of electric motors and generators, and to methods and apparatus for cooling such. For example, the present invention relates to a novel technique for dissipating heat in motors and generators by routing fluid along surfaces of a stator core. Although the present discussion focuses on electric motors and generators, the present invention affords benefits to a number of applications related to lamination stacks and to the cooling of such stacks.

Electric motors and generators of various types are commonly found in industrial, commercial and consumer settings. In industry, motors are employed to drive various kinds of machinery, such as pumps, conveyors, compressors, fans and so forth, to mention only a few. Conversely, generators translate kinetic energy into electrical energy. Conventional alternating current electric (ac) motors and generators may be constructed for single or multiple phase power, and are typically designed to operate at predetermined speeds or revolutions per minute (rpm), such as 3600 rpm, 1800 rpm, 1200 rpm, and so on. Such motors and generators generally include a stator, comprising a multiplicity of windings, surrounding a rotor, which is supported by bearings for rotation in the frame. In the case of ac motors, ac power applied to the motor causes the rotor to rotate within the stator. The speed of this rotation is typically a function of the frequency of ac input power (i.e., frequency) and of the motor design (i.e., the number of poles defined by the stator windings). A rotor shaft extending through the motor housing takes advantage of this produced rotation and translates the rotor's movement into a driving force for a given piece of machinery. That is, rotation of the shaft drives the machine to which it is coupled. By contrast, in generators, rotation of the magnetized rotor induces current in the stator windings, generating power.

During operation, conventional motors and generators generate heat. Indeed, the physical interaction of the devices various moving components produces heat by way of friction. Additionally, the electromagnetic relationships between the stator and the rotor produce currents that, in turn, generate heat due to resistive heating, for example. As yet another source of heat, ac magnetic fields lead to losses in the magnetic steel supporting the windings and conductors in the stator and rotor, respectively. If left unabated, excess heat may degrade the performance of the device. Worse yet, excess heat may contribute to any number of malfunctions, which may lead to system downtime and require maintenance. Undeniably, reduced efficiency and malfunctions are undesirable events that may lead to increased costs.

To dissipate heat, conventional motors and generators route a coolant, such as forced air or liquid coolant, through the stator or rotor and through the air gap between the stator and rotor. However, the tight fit between the stator and the frame supporting the stator prevents coolant from directly affecting the outer regions of the stator. Indeed, in traditional motors and generators, losses generated in the stator-whether in the conductors or in the magnetic steel-create heat in the stator that is typically dissipated by routing air or coolant over the outer surfaces of the frame.

In some cases, the motor or generator frame is surrounded by a coolant jacket through which cooling liquid (i.e., fluid) is routed. Unfortunately, such coolant jackets are an extra component that is assembled to the active parts of the motor or generator, leading to increased manufacturing costs. Furthermore, such cooling jackets are radially outward of the frame assembly, increasing the distance of cooling jacket from the heat generating components and, as such, limiting the overall efficacy of the cooling jacket. Generally, effective cooling of motors and generators is desired because excess heat in the stator windings, bearings, and rotor conductors, for example, can negatively influence the overall machine efficiency and component life, for instance.

The main magnetic path in an electric motor or generator is generally through the magnetic material that supports the stator or rotor conductors. This magnetic material makes up the stator and rotor core. To reduce magnetic flux produced losses, which generate heat, the magnetic core is laminated, with the lamination plane being in the same plane as the direction of the main magnetic flux path. In conventional radial air gap motors and generators, the stator and rotor core are, therefore, constructed from laminations that are assembled into an axial stack (i.e., a lamination stack). Traditionally, the lamination stack's outer surface is a smooth surface that is designed to be placed on and shrink fitted to the inner surface of a frame. Thus, the frame inner surface is in direct contact with the outer surface of the lamination stack in all locations circumferentially and axially along the lamination stack. In some cases, the frame is separated from the stator core in several locations to allow coolant flow or the passage of electrical wiring axially along the periphery of the stator core and between the core and the frame. In these types of core-to-frame constructions, the inner surface of the frame is generally machined or cast with well defined coolant paths that allow coolant flow over the outer smooth surfaces of the stator core. This special frame geometry adds complexity and cost to construction of the motor or generator stator.

There is a need, therefore, for improved methods and apparatus for cooling electric motors and generators. Moreover, there is a particular need for methods and apparatus that reduce temperature variations in the motor and provide a mechanism for cooling the outer regions of the stator.

### SUMMARY OF THE INVENTION

According to one embodiment, the present invention provides a lamination for an electric machine. The exemplary laminations are supported in a frame and cooperate with one another to form a lamination stack. Each exemplary lamination comprises a central aperture sized to receive a rotor, and a plurality of slots disposed circumferentially about the central aperture. These slots are configured to receive a plurality of windings. Additionally, the lamination comprises an outer periphery that defines a lamination cross-section such that the lamination is disposable in the frame. The outer periphery has at least one recessed section extending longitudinally between the ends of the lamination that is configured to cooperate with the frame to form a closed passageway for routing fluid. Accordingly, by routing fluid through the recessed sections of a plurality of laminations disposed within the frame, a mechanism for cooling the radially outward regions of the lamination stack that forms the stator is provided. Advantageously, cooling these outer regions of the stator improves the distribution of cooling resources. Additionally, to increase the efficacy of the cooling effect of the fluid, the recessed section of each lamination may be configured to cooperate with the frame and with adjacent laminations to form a labyrinthine passageway for routing the fluid along perimetric or peripheral surfaces of the assembled stator. Advantageously, the labyrinthine passageway provides a larger surface area of contact for the fluid while minimizing effects on structural integrity.

According to another exemplary embodiment, a lamination for a lamination stack is provided. The lamination includes a central aperture sized to receive a rotor and a plurality of slots disposed circumferentially about the central aperture at equiangular positions with respect to one another. Additionally, the lamination has an outer periphery that defines a generally circular lamination cross-section. The outer periphery also has at least one recessed section extending longitudinally between the ends of the lamination. The at least one recessed section is configured to cooperate with adjacent laminations of the stack to form a labyrinthine passageway extending along a circumferential surface of the lamination stack. Advantageously, a fluid may be routed through the labyrinthine passageway to dissipate heat developed in the lamination stack during operation of a motor, for example. As discussed above, the labyrinthine nature of the passageway creates a larger contact surface area for a cooling fluid routed through the passageway. Thus, the labyrinthine passageway facilitates more uniform cooling of the lamination stack and better dissipation of heat generated in the lamination slack or other loss producing elements of the machine.

According to another embodiment of the present invention, an electric motor is provided. The electric motor includes an enclosure that comprises first and second endcaps and a frame disposed between the endcaps. The exemplary motor also includes a stator core formed of a plurality of substantially identical stator laminations disposed in the frame. The plurality of substantially identical stator laminations each includes a recessed section that cooperates with the frame and one another to form a closed passageway for routing fluid along perimetric surfaces of the stator core. Advantageously, the closed passageway facilitates cooling of the outer portions of the stator core during operation of the motor. Moreover, the closed passageway forms a labyrinthine path for cooling fluid routed therethrough and, as such, provides a greater contact surface area for the cooling fluid in comparison to a direct axial passageway. By increasing the contact surface area of the cooling fluid, the efficacy of the convective cooling of the fluid is increased.

According to another embodiment of the present invention, an electric device having a frameless stator construction is provided. In this embodiment, the labyrinthine passageway extending through the stator core is formed by cooperation between appropriately configured apertures located within the stator lamination. That is to say, the labyrinthine passageways extend longitudinally through the stator lamination stack and radially inboard of the outer peripheral surface of the stack. Accordingly, improved cooling may be effectuated without use of a framed construction.

According to yet another exemplary embodiment of the present invention, a method for manufacturing a motor is provided. The method includes the act of providing a plurality of substantially identical laminations, wherein each lamination has at least one recessed section along an outer periphery of the lamination and longitudinally between the ends of the lamination. The exemplary method also includes the act of arranging the plurality of laminations with respect to one another to form a lamination stack, such that the at least one recessed section of the respective laminations cooperate to form a passageway extending along perimetric surfaces of the lamination stack. The lamination stack may be disposed within a motor frame such that the motor frame and the channel cooperate to form a closed passageway for routing fluid. Again, by routing fluid through the passageway, which extends axially and circumferentially along perimetric surfaces of the stack, the outer regions of the lamination stack can be more effectively cooled.

### BRIEF DESCRIPTION OF THE DRAWINGS

The foregoing and other advantages and features of the invention will become apparent upon reading the following detailed description and upon reference to the drawings in which:

FIG. 1 is a perspective view of an electric motor having features in accordance with an embodiment of the present invention;

FIG. 2 is a partial cross-section view of the motor of FIG. 1 along line 2-2;

FIG. 3 is a front view of a twelve-slot stator lamination disposed within a frame, which is illustrated in dashed line, in accordance with an embodiment of the present invention;

FIG. 4 is a diagrammatical representation of a pair of labyrinthine passageways formed between a lamination stack, which comprises of the lamination of FIG. 3, and a frame by altering the assembled orientation of the laminations with respect to one another within the frame, in accordance with an embodiment of the present invention;

FIG. 5 is a front view of a twenty-four-slot lamination disposed within a frame, which is illustrated in dashed line, in accordance with an embodiment of the present invention;

FIG. 6 is a diagrammatical representation of a pair of labyrinthine passageways formed between a lamination stack, which comprises of the lamination of FIG. 5, and a frame by altering the assembled orientation of the laminations with respect to one another within the frame, in accordance with an embodiment of the present invention;

FIG. 7 is a front view of a thirty-six-slot stator lamination disposed within a frame, which is illustrated in dashed line, in accordance with an embodiment of the present invention;

FIG. 8 is a diagrammatical representation of a series of labyrinthine passageways formed between a lamination stack, which comprises the lamination of FIG. 7, and a frame by altering the assembled orientation of the laminations with respect to one another within the frame, in accordance with an embodiment of the present invention;

FIG. 9 is a front view of a twelve-slot motor stator lamination disposed within a frame, in accordance with an embodiment of the present invention;

FIG. 10 is a diagrammatical representation of a pair of labyrinthine passageways formed between a lamination stack, which comprises the lamination of FIG. 9, and a frame by altering the assembled orientation of the laminations with respect to one another in the frame, in accordance with an embodiment of the present invention;

FIG. 11 is an exemplary recessed section of a stator lamination, the recesses section having an L-shaped cross-section, in accordance with an embodiment of the present invention;

FIG. 12 illustrates an exemplary recessed section of a stator lamination, the recesses section having an T-shaped cross-section, in accordance with an embodiment of the present invention;

FIG. 13 illustrates an exemplary recessed section of a stator lamination, the recesses section having an S-shaped cross-section, in accordance with an embodiment of the present invention;

FIG. 14 illustrates an exemplary an exemplary recessed section of a stator lamination, the recesses section having a series of finger-like projections, in accordance with an exemplary embodiment of the present invention;

FIGS. 15a and 15b are respective front views of stator laminations that are each disposed in a frame, which is illustrated in dashed line, in accordance with an embodiment of the present invention;

FIG. 16 is a diagrammatical representation of a series of labyrinthine passageways formed between a lamination stack, which comprises the laminations of FIGS. 15a and 15b, and a frame by altering the assembled orientations of the stator laminations of the stack with respect to one another;

FIG. 17 illustrates an exemplary process for manufacturing an electrical device, in accordance with an embodiment of the present invention; and

FIG. 18 is a front view of a 12-slot stator lamination for a frameless stator lamination stack, in accordance with an embodiment of the present invention.

### DETAILED DESCRIPTION OF SPECIFIC EMBODIMENTS

As discussed in detail below, embodiments of the present invention provide apparatus and methods for cooling electric machines having lamination stacks. Although the discussion regarding the present invention focuses on electric motors and generators, the present invention also affords benefits to a number of applications in which the cooling of a lamination stack is a concern. Accordingly, the following discussion relates to exemplary embodiments of the present invention and, as such, should not be viewed as limiting the appended claims to the embodiments described.

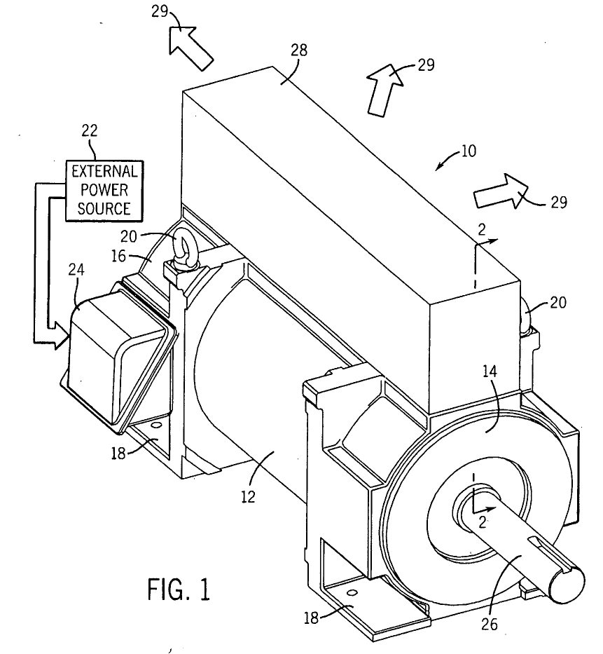

Turning to the drawings, FIG. 1 illustrates an exemplary electric motor 10. In the embodiment illustrated, the motor 10 comprises an induction motor housed in a motor housing. The exemplary motor 10 comprises a frame 12 capped at each end by drive-end and opposite drive-end endcaps 14 and 16, respectively. The frame 12 and the endcaps 14 and 16 cooperate to form the enclosure or motor housing for the motor 10. Additionally, if desired, the frame 12 and the endcaps 14 and 16 may be configured to form a hermetically sealed enclosure for the motor 10. The frame 12 and the front and rear endcaps 14 and 16 may be formed of any number of materials, such as steel, aluminum, or any other suitable structural material. The endcaps 14 and 16 may include mounting and transportation features, such as the illustrated mounting flanges 18 and eyehooks 20. Those skilled in the art will appreciate in light of the following description that a wide variety of configurations and devices may employ the cooling and construction techniques outlined below.

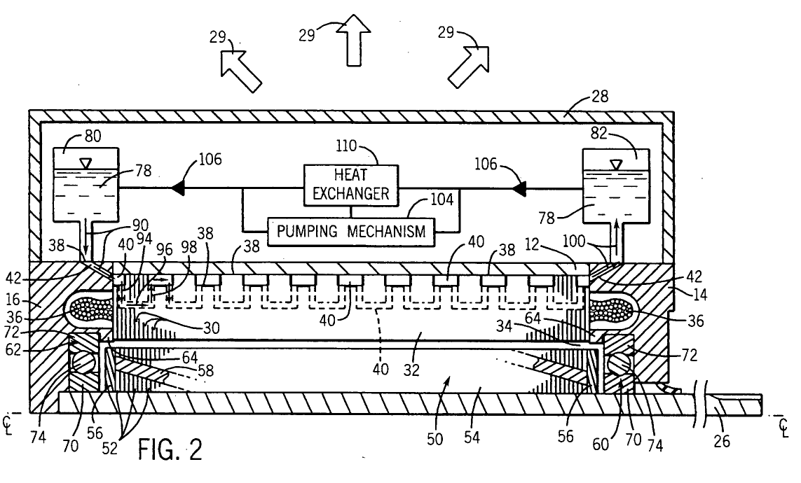

To induce rotation of the rotor, current is routed through stator windings disposed in the stator. (See FIG. 2.) These stator windings are electrically interconnected to form groups, which are, in turn, interconnected in a manner generally known in the pertinent art. The stator windings are further coupled to terminal leads (not shown), which electrically connect the stator windings to an external power source 22. This external power source may provide any number of types and levels of suitable power. Indeed, the external power source 22 may comprise an ac pulse width modulated (PWM) inverter as well as an adjustable frequency power source. A conduit box 24 houses the electrical connection between the terminal leads and the external power source 22. The conduit box 24 comprises a metal or plastic material and, advantageously, provides access to certain electrical components of the motor 10. Routing electrical current from the external power source 22 through the stator windings produces a magnetic field that induces rotation of the rotor. A rotor shaft 26 coupled to the rotor rotates in conjunction with the rotor. That is, rotation of the rotor translates into a corresponding rotation of the rotor shaft 26. As appreciated by those of ordinary skill in the art, the rotor shaft 26 may couple to any number of driven machine elements, thereby transmitting torque to the given driven machine element. By way of example, machines such as pumps, compressors, fans, conveyors, and so forth, may harness the rotational motion of the rotor shaft 26 for operation. Alternatively, as appreciated by those of ordinary skill in the art, rotation of a magnetized rotor induces current in the stator windings and allows the electrical machine to act as a generator.

During operation, the motor 10 generates heat. By way of example, the physical interaction between various components of the motor 10 generates heat via friction. Additionally, current in the stator windings as well as in the rotor generates heat via resistive heating. Moreover, in the case of ac motors, eddy currents developed in the stator laminations and as well as hysteresis losses in the stator also produce heat. If left unabated, excess heat leads to a degradation in performance of the motor 10 and, in certain instances, may lead to malfunction of the motor. To improve heat dissipation, the illustrated motor 10 carries a cooling assembly 28 mounted to the motor housing and configured to convectively cool the motor 10. As discussed further below, the cooling assembly 28 circulates a fluid (e.g., liquid coolant or air) through the motor, thereby convectively cooling the motor. Simply put, the cooling assembly 28 convectively cools the motor 10 by dissipating heat into the environment surrounding the motor 10, as represented by arrows 29. It is worth noting that the motor may carry a plurality of cooling units 28, if desired.

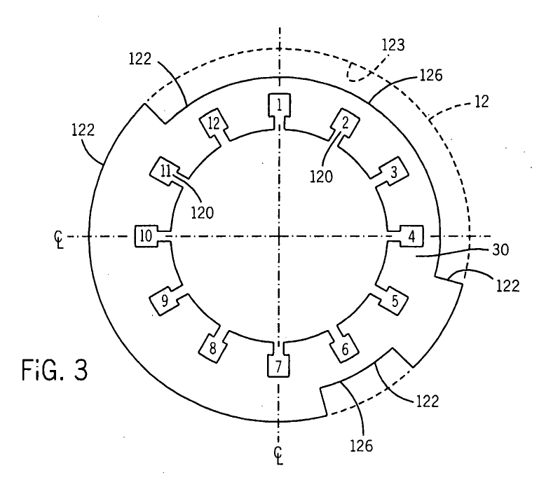

FIG. 2 is a partial cross-section view of the motor 10 of FIG. 1 along line 2-2. To simplify the discussion, only the top portion of the motor 10 is shown, as much of the structure of the illustrated motor 10 is essentially mirrored along its centerline. As discussed above, the frame 12 and the endcaps 14 and 16 cooperate to form an enclosure or motor housing for the motor 10. Within the enclosure or motor housing resides a plurality of stator laminations 30 juxtaposed and aligned with respect to one another to form a lamination stack, such as the illustrated contiguous stator core 32. In the exemplary motor 10, each stator lamination 30 includes features that cooperate with one another to form cumulative features for the contiguous stator core 32. For example, each stator lamination 30 includes a central aperture (see FIG. 3) that cooperates with the central aperture of adjacent laminations to form a rotor chamber 34 that extends the length of the stator core 32 and that is sized to receive a rotor. Additionally, each stator lamination 30 includes a plurality of slots (see FIG. 3) disposed circumferentially about the central aperture. These slots cooperate to receive one or more stator windings 36, which are illustrated as coil ends in FIG. 2, that extend the length of the stator core 32. Furthermore, and as discussed further below, each stator lamination 30 includes at least one recessed portion (see FIG. 3) located on the outer periphery of the lamination that, when arranged in a lamination stack, form a channel or passageway along the outer surface of the stator core 32 (i.e., lamination stack).

In cooperation with the frame 12, the recessed section of each lamination 30 defines an incremental segment of a closed and contiguous passageway 40 that extends axially along an outer or perimetric surface 38 of the stator core 32. In FIG. 2, portions of the closed passageway 40 located behind the cross-section view are illustrated in dashed line. The endcaps 14 and 16 each include arteries 42 that facilitate access to the closed passageway 40 of an assembled motor 10. By way of example and as discussed further below, the arteries 42 provide an inlet or an outlet for circulating fluid through the closed passageway 40. The laminations are envisaged as being substantially identical to one another or, alternatively, having variations with respect to one another. Various shapes and profiles for the laminations are discussed further below.

In the exemplary motor 10, a rotor assembly 50 resides within the rotor chamber 34. Similar to the stator core 32, the rotor assembly 50 comprises a plurality of rotor laminations 52 aligned and adjacently placed with respect to one another. Thus, the rotor laminations 52 cooperate to form a contiguous rotor core 54. The exemplary rotor assembly 50 also includes rotor end rings 56, disposed on each end of the rotor core 54, that cooperate to secure the rotor laminations 52 with respect to one another. It is worth noting, however, that the rotor may be a cast rotor or a fabricated rotor, for instance. When assembled, the rotor laminations 52 cooperate to form shaft chamber that extends through the center of the rotor core 54 and that is configured to receive the rotor shaft 26 therethrough. Once inserted, the rotor shaft 26 is secured with respect to the rotor core 54. Accordingly, the rotor core 54 and the rotor shaft 26 rotate as a single entity, the rotor assembly 50. The exemplary rotor assembly 50 also includes rotor conductor bars 58 disposed in the rotor core 54. As discussed further below, inducing current in the rotor assembly 50, specifically in the conductor bars 58, causes the rotor assembly 50 to rotate. By harnessing the rotation of the rotor assembly 50 via the rotor shaft 26, a machine coupled to the rotor shaft 26, such as a pump or conveyor, may operate.

To support the rotor assembly 50, the exemplary motor 10 includes drive-end and opposite drive-end bearing sets 60 and 62, respectively, that are secured to the rotor shaft 26 and that facilitate rotation of the rotor assembly 50 within the stationary stator core 32. During operation of the motor 10, the bearing sets 60 and 62 transfer the radial and thrust loads produced by the rotor assembly 50 to the motor housing. In summary, the bearing sets 60 and 62 facilitate rotation of the rotor assembly 50 while supporting the rotor assembly 50 within the motor housing, i.e., the frame 12 and the endcaps 14 and 16. To reduce the coefficient of friction between various components of the bearing sets 60 and 62, these components are coated with a lubricant. During operation, however, the physical interaction of and within the bearing sets 60 and 62 generate heat.

As discussed above, the exemplary motor 10 includes a cooling assembly 28 that dissipates heat generated in the motor 10 during operation. The cooling assembly 28 can comprise an assembly of parts or, alternatively, a self-contained unit housed in a single assembly as illustrated in FIG. 2. The cooling assembly 28 circulates a fluid, such as a liquid coolant 78 or forced air, along perimetric surfaces 38 of the stator core 32 to convectively cool the motor 10. The exemplary cooling assembly 28 includes input and output reservoirs 80 and 82, respectively, that maintain an adequate supply of liquid coolant 78. The input reservoir 80 communicates with the closed passageway 40 via the artery 42 located in the rear endcap 16. Accordingly, liquid coolant 78 flows from the input reservoir 80 to the entrance of the closed passageway 40 via the ingress artery 42, as represented by arrows 90. However, it is worth noting again that the coolant may be any fluid, liquid or gaseous, including air.

As coolant 78 enters the closed passageway 40, the impermeable surfaces of the respective stator laminations 30 and the frame 12 cooperate to route the coolant 78 through the passageway 40 and along the perimetric surfaces 38 of the stator core. In the exemplary embodiment, the stator laminations 30 and the frame 12 cooperate to change the direction of the flow of the coolant 78 (i.e., route the coolant) down the perimetric surfaces 38 of the stator core 32, as represented by directional arrow 94. Subsequently, the closed passageway 40 routes the coolant 78 axially along surface 38 of the stator core 32, as represented by directional arrow 96. The closed passageway then routes the coolant 78 back up the perimetric surfaces 38 of the stator core 32, as represented by directional arrow 98. By repeating this route axially along the length of the stator core 32, the closed passageway 40 routes the coolant 78 in a labyrinthine path along the perimetric surfaces of the stator core. As the coolant 78 reaches the exit end of the closed passageway 40, an egress artery 42 located in the drive-end endcap 14 meets the closed passageway 40 and receives the coolant 78. This artery 42 routes the fluid to the output reservoir 82, as represented by arrows 100.

To maintain sufficient pressure differential for circulating the coolant 78, the exemplary cooling assembly 28 includes a pumping mechanism 104. Alternatively, in the case of a gaseous cooling fluid, the pumping mechanism 104 includes a fan. As illustrated, the pumping mechanism 104 draws fluid from the output reservoir 82 and to the input reservoir 80, as represented by directional arrows 106. Advantageously, the pumping mechanism 104, the reservoirs 80 and 82, the arteries 42, and the passageway 40 cooperate to form a closed system. Thus, circulating coolant 78 is, for the most part, conserved.

By circulating coolant 78 through the closed passageway 40, the coolant 78 draws in heat from the stator core 32. More particularly, the coolant 78 comes into contact with the perimetric surfaces 38 of the stator core 32 and absorbs some of the heat generated by operation of the motor 10. The proximity of the closed passageway 40 to the radially outward regions of the stator core 32 provides a mechanism for focusing cooling on such regions. Thus, the likelihood of uneven cooling or hotspots in the motor can be mitigated. In the exemplary embodiment, the passageway 40 provides an indirect or labyrinthine path for the coolant along the surfaces of the stator core 32. Accordingly, the coolant 78 comes into contact with a larger portion of the perimetric surface 38 of the stator core 32 in comparison to a direct axial path and, as such, absorbs more heat into the circulating coolant 78.

Once the coolant 78 has circulated through the closed passageway 40, a heat exchanger 110, located in the housing of the cooling assembly 28, facilities dissipation of the absorbed heat from the coolant 78 into the environment, as represented by arrows 29. By way of example, the heat exchanger 110 may include a series of flat plates across which the coolant 78 is directed. The flat plates increase the circulating surface area of the coolant 78 and, as such, facilitate improved dissipation of the absorbed heat in the coolant 78 to the environment. In any event, after the absorbed heat in the coolant 78 has been dissipated, the coolant 78 is directed back into the input reservoir 80 and the circulation cycle is repeated.

FIG. 3 provides a front view of an exemplary stator lamination 30 disposed in a motor frame 12, which is illustrated in dashed line. The exemplary stator lamination 30 has twelve slots 120 disposed at equiangular positions with respect to one another and consecutively numbered in a clockwise direction. The slots 120 are configured to receive stator windings 36 (see FIG. 2), as appreciated by those of ordinary skill in the art. This stator lamination 30 has an outer periphery 122 or edge that defines the lamination's 32 generally circular shape (i.e., cross-section). It is worth noting, however, that the lamination may have any number of shapes, including angular and arcuate shapes. When installed, much of the outer periphery 122 abuts the inner surface 123 of the frame 12 and, as such, creates a tight fit between the two structures. However, the outer periphery 122 also includes a pair of recessed sections 126. The recessed sections 126 are radially closer to the center of the lamination 30 in comparison to the remainder of the outer periphery 122 and, as such, do not abut the frame 12. Accordingly, the recessed sections 126 form channels and, in cooperation with the frame 12, a closed passageway. When arranged in a lamination stack to form the stator core 32, the recessed sections 126 of each lamination comprises an incremental section of the cumulative passageway 40 (see FIG. 2) that extends the length of the stator core 32.

Advantageously, the recessed sections 126 may be configured to form a labyrinthine path for the coolant 78 (see FIG. 2) as it is routed through the passageway 40 (see FIG. 2). That is, the stator laminations 30 may be configured to form a channel that routes coolant 78 both axially and circumferentially along the perimetric surface 38 (see FIG. 2) of the motor, which is cumulatively defined by the outer periphery of the laminations 32.

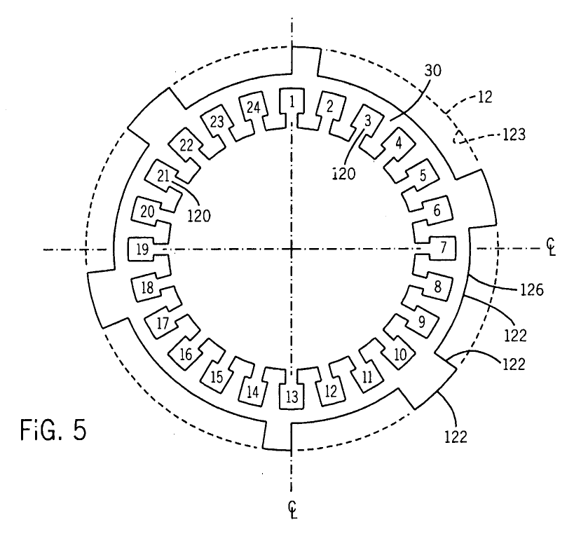

In the illustrated lamination 30, the larger recessed portion 126 begins at an angular position midway between “Slot 11” and “Slot 12” and extends along the outer periphery 122 to a radial position midway between “Slot 4” and “Slot 5.” The smaller recessed portion 126 begins at an angular position midway between “Slot 5” and “Slot 6” and extends to an angular position midway between “Slot 6” and “Slot 7.” For the purposes of this discussion, the larger recessed section is said to correspond with Slots 12 through 4 and the smaller recessed section is said to correspond with Slot 6. This nomenclature scheme extends to the laminations 30 illustrated in FIGS. 5, 7, and 9, which are discussed in further detail below. However, it is worth noting that the correspondence need not be limited to the angular midpoint between slots, and that the correspondence with a slot may extend from any point after the proceeding slot and prior to the subsequent slot.

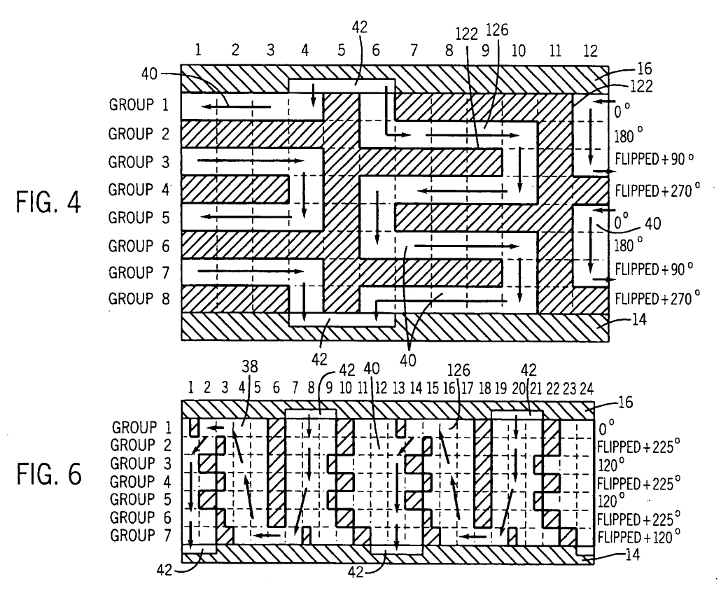

When arranged in a lamination stack or stator core 32, the lamination 30 of FIG. 3 may be oriented to form, in cooperation with the frame 12, a pair of passageways 40 that axially and circumferentially traverses (i.e., a labyrinthine path) the perimetric surfaces 38 of the stator core 32. (See FIG. 2.) For example, FIG. 4 is a planar chart or diagram representing the perimetric surface 38 of a stator core 32 formed of the lamination 30 of FIG. 3. In this chart, each incremental column represents a portion of the outer periphery 122 that corresponds to a slot 120 in the stator lamination 32 and each incremental row represents a grouping of stator laminations 30 in the stator core 32 that have the same orientation. With respect to the orientation of FIG. 4, the upper-left most block represents the origin of the chart, i.e., coordinates (0,0). Moreover, the shaded regions in the chart represent the abutment of the outer periphery 122 of the lamination 32 and the frame 12, which prevents the flow of coolant 78, and the unshaded regions represent the recessed sections 126 of the various laminations 30 that cooperate to form the passageway 40 on the perimetric surface 38 of the stator core 32. This convention is also employed in relation to the charts illustrated in FIGS. 6, 8, 10, and 16, which are discussed further below.

The stator core 32 is capped on each end by drive-end and opposite drive-end endcaps 14 and 16, respectively. As discussed above, each endcap 14 and 16 includes at least one artery 42 that facilitates coolant flow into or out of the passageways 40 of the stator core 32. The first row in the chart represents a group of laminations 30 (Group 1) disposed in the frame 12 in the orientation illustrated in FIG. 3. In Group 1, the recessed sections 126 corresponding with Slot 4 and Slot 6 receive coolant 78 from the artery 42 in the rear endcap 16. The second row in the chart represents a second group of stator laminations 30 (Group 2) that are substantially identical to the laminations in Group 1; however, the laminations of Group 2 are oriented 180 degrees clockwise from the orientation of Group 1. Thus, coolant 78 is routed in the passageway 40 from the recessed section corresponding to Slot 4 of Group 1 to the recessed section corresponding to Slot 12 of Group 2 and from the recessed section corresponding to Slot 6 of Group 1 to the recessed section corresponding to Slot 10 of Group 2. The third row in the chart represents a third group of stator laminations (Group 3) that are oriented in a mirror-image fashion (i.e., flipped) and rotated clockwise 90 degrees with respect to the orientation illustrated in FIG. 3, i.e., Group 1. Accordingly, coolant 78 is routed from Slot 12 of Group 2 to Slot 4 of Group 3 and from Slot 10 of Group 2 to the Slot 10 of Group 3. The next group of laminations, i.e., Group 4, is oriented in a mirror-image fashion and rotated clockwise 270 degrees with respect to the orientation of Group 1. Accordingly, coolant is routed from Slot 4 of Group 3 to Slot 4 of Group 4 and from Slot 10 of Group 3 to Slot 6 of Group 4.

This orientation pattern is repeated for the remaining groups, i.e., the orientation of Group 5 matches the orientation of Group 1, the orientation of Group 6 matches the orientation of Group 2, and so on. Thus, when coolant 78 reaches the last group in the stator core 32, Group 8, the two passageways 40 both feed into the artery 42 in the drive-end endcap 14, and coolant 78 is circulated through the cooling assembly 28 as described above. By routing coolant 78 in a labyrinthine path, coolant 78 comes into contact with a larger portion of the perimetric surfaces 38 of the stator core 32 in comparison to a direct axial path, and, as such, increases the efficacy of the circulating coolant 78. Additionally, it should be noted that although the recessed section 126 pattern is presented for a twelve-slot stator core 32, the pattern is applicable to stator cores 32 that have an integer multiple of the twelve-slot pattern, e.g., twenty-four-slot, thirty-six-slot, etc. Advantageously, radially recessed portions of each stator lamination facilitates the circulation of coolant 78 between the smooth, unmachined inner surface of the frame 12 and the outer peripheral surface of each respective lamination. Thus, a coolant path can be provided without machining of the frame, which is an often difficult and expensive process.

FIG. 5 illustrates an alternate embodiment of the present invention. In this embodiment, the stator lamination 30 has a twenty-four-slot pattern. Accordingly, the exemplary lamination 30 is well suited for a three-phase induction motor. However, as discussed above, the lamination 30 pattern is applicable to a lamination 30 that has an integer multiple of the twelve-slot pattern. In this embodiment, the recessed portions are arranged as follows: 1) from Slot 2 to Slot 5; 2) from Slot 7 to Slot 9; 3) from Slot 14 to Slot 17; and 4) from Slot 19 to Slot 21. Additionally, the exemplary lamination 30 includes an extended recessed section that extends from a location corresponding to Slot 23 and partially into a location corresponding to Slot 1 and another extended slot that extends from Slot 11 and partially into a location corresponding to Slot 13, both approximately to the midway point of Slot 1 and 13, respectively.

FIG. 6 is a graphical representation of exemplary labyrinthine passageways extending along perimetric surfaces 38 of the stator core 32 that is formed of the lamination of FIG. 5. In the exemplary arrangement, each passageway routes coolant axially from end-to-end three time. That is, coolant in each path traverses the axial length of the stator core 32 three time. As with FIG. 4, the stator core 32 is capped on each end by drive-end and opposite drive-end endcaps 14 and 16, and the first row in the chart represents a group of laminations 30 (Group 1) disposed in the frame 12 in the orientation illustrated in FIG. 5. The arteries 42 in the opposite drive-end endcap 16 provide points of ingress for coolant 78 into the passageways. Accordingly, coolant is received by the recessed sections 126 corresponding with Slot 19 to Slot 21 and Slot 7 to Slot 9. The laminations 30 of Group 2 are flipped (i.e., mirror-image orientation) and rotated 225 degrees clockwise with respect to the orientation of Group 1. The next group of laminations 30 (Group 3) is oriented at 120 degrees clockwise with respect to Group 1. This pattern repeats, as Group 4 and Group 6 are orientated as Group 2 and Group 5 is orientated as Group 3. To facilitate egress of the coolant 78, the last group of laminations 30 (Group 7) is flipped and rotated 120 degrees with respect to the orientation of Group 1. Accordingly, the recessed sections corresponding to Slot 11 to Slot 13 and Slot 24 to Slot 1 align with the arteries 42 located in drive-end endcap 14 and serve as the egression points for the coolant 78 from the passageways 40.

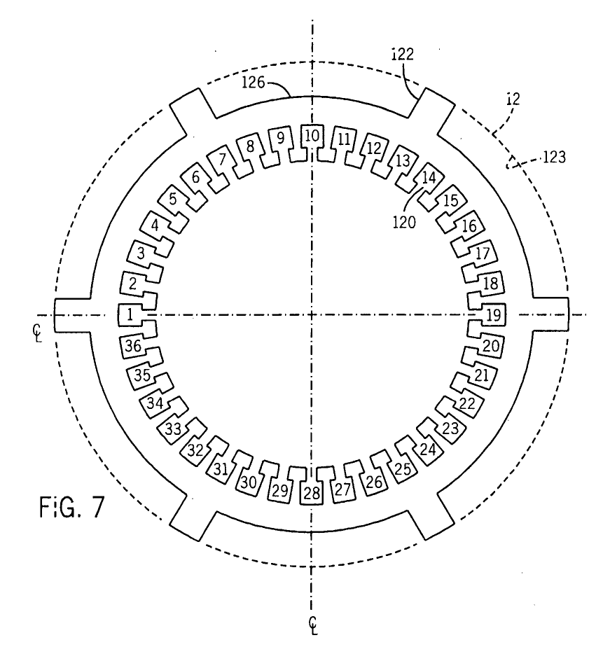

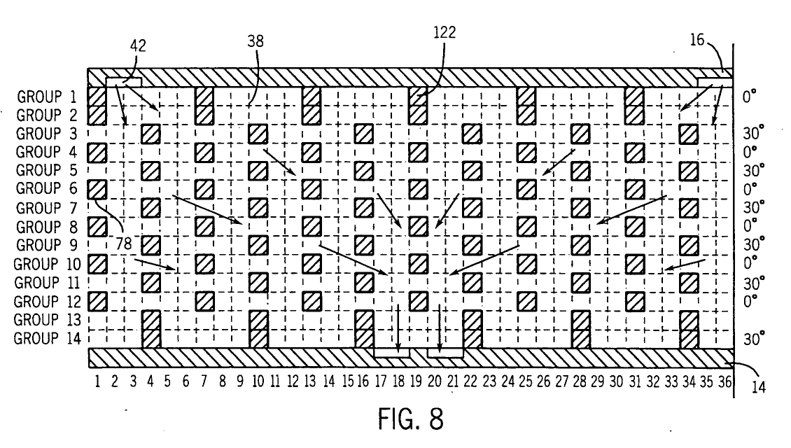

FIG. 7 illustrates yet another design or pattern for a lamination 30, in accordance with an exemplary embodiment of the present invention. In this embodiment, the stator lamination 30 comprises a thirty-six-slot pattern. Accordingly, the exemplary lamination 30 is well suited for a three-phase induction motor. However, as with the other exemplary lamination patterns discussed, the lamination pattern is equally applicable to a lamination that has an integer multiple of the twelve-slot pattern. In this embodiment, the recessed sections correspond with: Slot 2 to Slot 6; Slot 8 to Slot 12; Slot 14 to Slot 18; Slot 20 to Slot 24; Slot 26 to Slot 30; and Slot 32 to Slot 36. FIG. 8 presents a graphical representation of an exemplary labyrinthine passageway extending along the perimetric surfaces 38 of the stator core 32 that is formed of the lamination 30 of FIG. 7. In the exemplary embodiment, altering the location of the ingress and egress arteries facilitates the creation of circumferentially routed flow paths. By offsetting alternating groups of laminations (e.g., by 30 degrees clockwise), turbulence that creates a labyrinthine paths for the coolant 78 is produced. Alternatively, by limiting the number of ingress and egress arteries 42, as illustrated in FIG. 8, more of a circumferential path for the fluid may be formed.

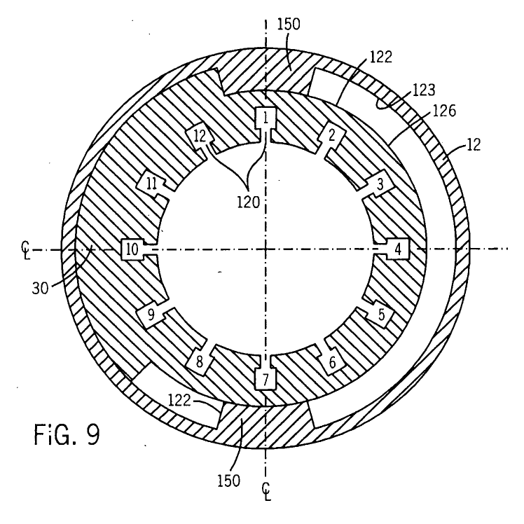

FIG. 9 illustrates an embodiment of the present invention in which the frame 12 includes features that facilitate formation of the labyrinthine passageways for routing the coolant 78. Although illustrated for a twelve-slot lamination pattern, this arrangement is applicable to a lamination pattern that has any number of slot patterns. In this embodiment, the recessed sections 126 of the lamination 30 correspond with Slot 1 to Slot 8. To form the labyrinthine passageways, however, the frame 12 includes a pair of tabbed portions 150 that extend radially inward from the inner surface 123 of the frame 12. To prevent the seepage of coolant 78, the tabbed portions 150 present good tolerances with respect to the outer periphery 122 of the laminations 30. As illustrated in FIG. 9, the frame 12 includes two tabbed portions 150 that correspond with Slot 1 and Slot 7 of the lamination 30.

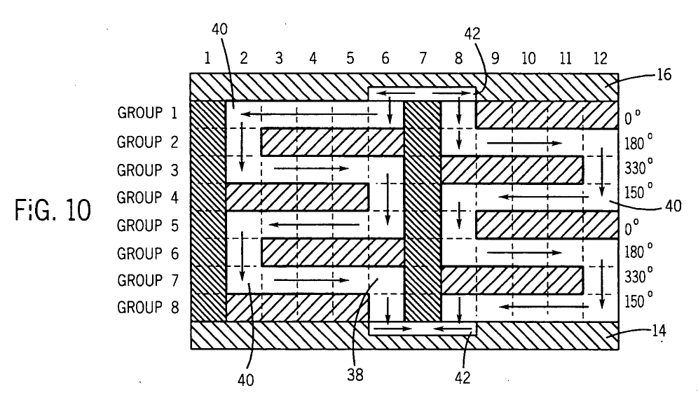

FIG. 10 presents a graphical representation of an exemplary labyrinthine passageway extending along the perimetric surfaces 38 of the stator core 32 that is formed of the lamination 30 of FIG. 9. To form the passageway, the laminations 30 cooperate with the tabbed portions 150 of the frame 12. In the exemplary embodiment, the tabbed portions 150 of the frame 12 extend the axial length of the stator core 32. Accordingly, the tabbed portions 150 act as dividers that isolate the labyrinthine passageways from one other. However, if desired, the tabbed portions 150 may include areas of discontinuity, thereby facilitating coupling the various passageways. In the exemplary arrangement, the first group of laminations (Group 1) is oriented in the frame as illustrated in FIG. 9. Accordingly, the ingress artery 42 in the opposite drive-end endcap 16 provides coolant to the recessed sections corresponding with Slot 6 and Slot 8. That is, the first passageway begins at Slot 6 and the second flow passageway begins at Slot 8.

Beginning with the first passageway, the first group of laminations (i.e., Group 1) routes coolant from Slot 6 of the first Group to Slot 2 of the second group of laminations (i.e., Group 2). Group 2 is oriented at 180 degrees clockwise with respect to Group 1. The coolant 78 is then routed from Slot 2 of Group 2 to Slot 6 of Group 3. Group 3 is oriented at 330 degrees clockwise with respect to Group 1. Coolant 78 is then routed from Slot 6 of Group 3 to Slot 6 of Group 4. Group 4 is orientated at 150 degrees clockwise with respect to Group 1. This orientation pattern is repeated axially with respect to the stator core 32, as the orientation of Group 5 corresponds to the orientation of Group 1, the orientation of Group 6 corresponds to Group 2, the orientation of Group 7 corresponds to Group 3, and the orientation of Group 8 corresponds to Group 4. The first passageway concludes at Slot 6 of Group 8, as coolant is routed into the egress artery 42 located in the drive-end endcap 14.

The second passageway 40 presents a labyrinthine flow path that is the mirror image of the first passageway. In this passageway 40, coolant 78 is provided to the recessed section corresponding with Slot 8 of Group 1 via the ingress artery 42 in the opposite drive-end endcap 16. Coolant 78 is then routed in the passageway from Slot 8 of Group 1 to Slot 8 of Group 2. Subsequently, coolant 78 is routed from Slot 8 of Group 2 to Slot 12 of Group 3. From this position in the second passageway, coolant 78 is routed from Slot 12 of Group 3 to Slot 6 of Group 4. This pattern is repeated, as the orientation of Group 5 matches the orientation of Group 1, the orientation of Group 6 matches that of Group 2, and so on. Upon its conclusion, the second passageway routes coolant 78 into the egress artery 42 in the drive-end endcap 14, and the processes is repeated as coolant 78 is circulated.

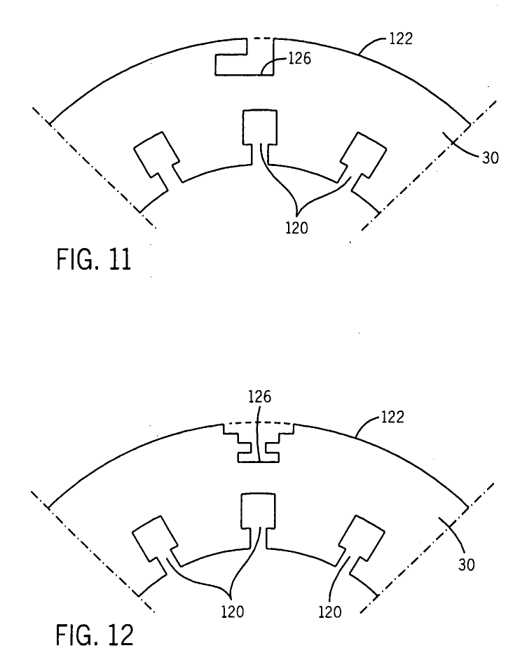

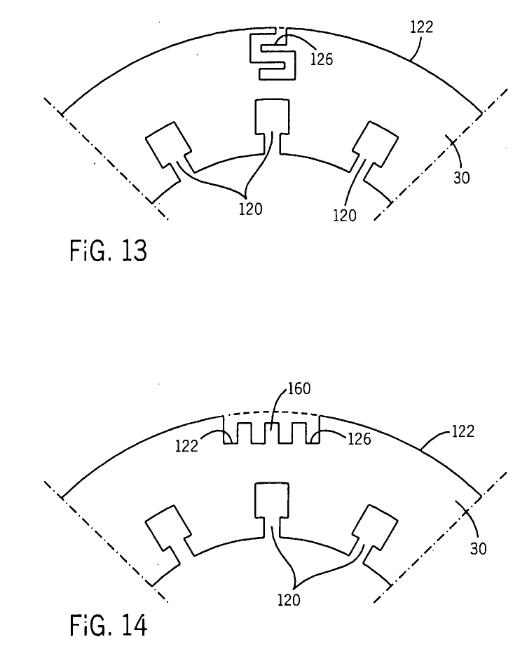

Additionally, the recessed sections 126 may present more complex cross-sections configured to increase the contact surface area between the circulating coolant and the perimetric surfaces 38 of the respective stator core 32. By way of example, FIGS. 11-14 present various cross-section shapes for the recessed sections 126. FIG. 11 illustrates a recessed section 126 having an L-shaped cross-section; FIG. 12 illustrates a recessed section 126 having a T-shaped cross-section; and FIG. 13 illustrates a recessed section 126 having an S-shaped cross-section. As yet another exemplary cross-section shape for a recessed section 126, FIG. 14 illustrates a recessed section 126 including a series of finger like 160 projections extending radially outward from the outer periphery 122. Again, each of the exemplary recessed sections provide a larger surface area of contact between the coolant 78 and stator core 32 in comparison to a simple rectangular-shaped recessed section having a larger cross-section area.

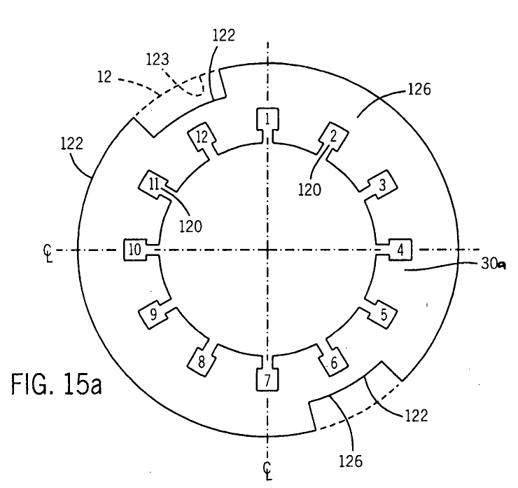

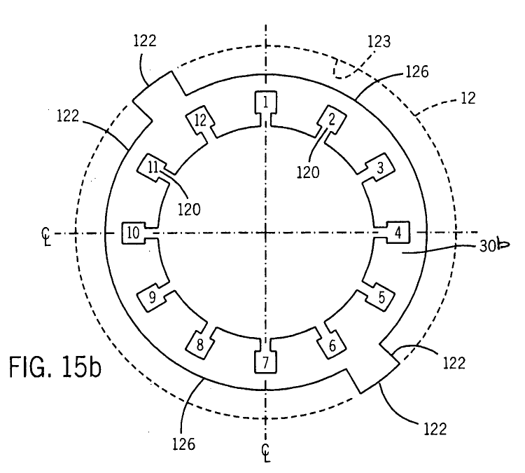

Turning to FIGS. 15a and 15b, these figures illustrate an alternate embodiment of the present invention in which the coolant pathways are formed via the cooperation between the frame 12 and stator laminations 30 having different profiles. In this embodiment, the first stator lamination 30a of FIG. 15a and the second lamination 30b of FIG. 15b both present a 12-slot pattern. Again, as with the other exemplary lamination patterns discussed above, the lamination pattern is equally applicable to laminations having an integer multiple of the 12-slot pattern. As illustrated, the recessed sections 126 of the first lamination 30a correspond to Slots 12 and 6. And the recessed sections 126 of the second stator lamination 30b correspond with Slots 1 to 5 and Slots 7 to 11. Specifically, in the second stator lamination 30b, the recessed section 126 extends from midpoint of Slot 12 to a point midway between Slots 5 and 6, and from the midpoint of slot 6 to a point midway between Slots 11 and 12.

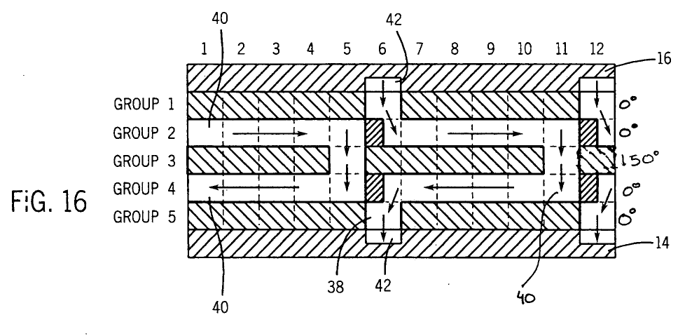

FIG. 16 presents a graphical representation of exemplary labyrinthine passageways extending along the perimetric surfaces 38 of the stator core that is formed of alternating arrangements of the first lamination 30a and the second lamination 30b of FIGS. 15a and 15b. When assembled axially with respect to one another, the laminations 30a and 30b form the labyrinthine passageways for the coolant 78. Specifically, in this embodiment, the recessed sections 126 of laminations 30a and 30b form two passageways extending along the perimetric surfaces of the stator core 38. Group I comprises a series of first laminations 30a arranged in the orientation illustrated in FIG. 15a. And Group II comprises a series of second laminations 30b arranged in the orientation illustrated in FIG. 15b. Group III comprises a series of first laminations 30a rotated 150 degrees clockwise from the orientation illustrated in FIG. 15a. Group IV comprises a series of laminations of the second group arranged in the orientation of FIG. 15b, and Group V, the conclusion, laminations of FIG. 15a arranged as illustration in FIG. 16.

Coolant ingresses at the recessed section corresponding to Slot 6 of the first stator lamination group (i.e. Group I). Because the recessed section of the second lamination 30b extends part way into the region angularly corresponding to Slot 6, fluid from the Group I laminations is routed into the recessed portion corresponding to half of Slot 6 of Group II. In Group II, fluid is routed from half way into Slot 6 to Slot 11. From this location, coolant is routed into Slot 11 of Group III and to halfway into Slot 6 of Group IV. From Slot 6 of Group IV, coolant is routed to Slot 6 of Group V and into the egress artery 42 for recirculation.

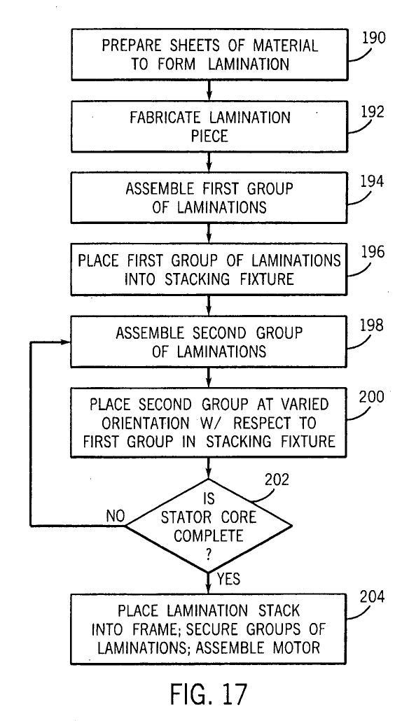

Keeping FIGS. 1-16 in mind, FIG. 17 illustrates an exemplary process for the manufacture and assembly of a motor 10 in accordance with an embodiment of the present invention. The process includes preparing sheets of material to form the laminations. (Block 190.) By way of example, pre-fabricated sheet metal may be cleaned and/or finished for use in a motor 10. The exemplary process also includes fabricating a piece of lamination 30. (Block 192.) The lamination may be formed by stamping a piece of sheet metal, thereby creating the desired pattern in the sheet metal. A series of laminations are collected to form a group of laminations all arranged in the same orientation. (Block 194.) Each group of laminations comprises an incremental segment of the stator core 32. The exemplary process also includes placing a first group of laminations in a stacking fixture. (Block 196.) A second group of laminations, oriented differently with respect to the first group, is also placed into the stacking fixture. (Blocks 198 and 200.) As discussed above, the frame 12 and the staggered groups of laminations cooperate to form a labyrinthine passageway 40 extending axially along the perimetric surface 38 of the formed stator core 32. As also discussed above, routing coolant 78 through the passageway 40 facilitates cooling of the stator core 32 and the motor as a whole. If the construction of the stator core 32 is complete (Block 202), then the motor 10 may be assembled by securing the groups of laminations in the frame 12 and securing the endcaps 14 and 16 to the frame. (Block 204.) However, if not complete, more groups of laminations may be added to the stacking fixture, as represented by Block 198.

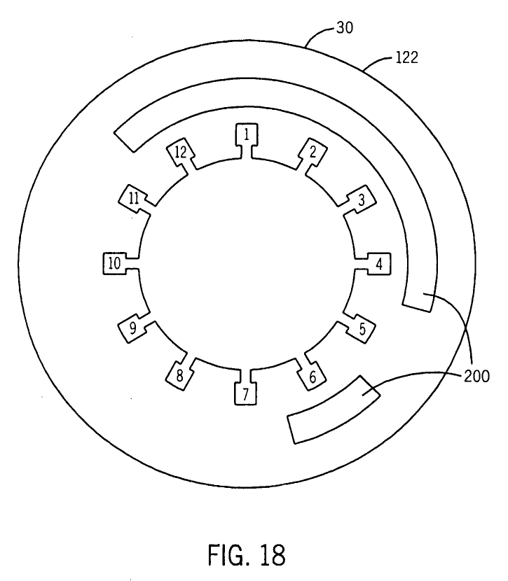

Turning to FIG. 18, this figure illustrates an alternate, exemplary embodiment of a stator lamination 30 that facilitates a frameless stator lamination stack construction. In other words, cooperating stator laminations 30, when assembled with respect to one another, provide the outer peripheral surface of the electrical device, thus vitiating the need for a frame assembly. Similar to the stator lamination illustrated in FIG. 3, the present stator lamination 30 includes a central aperture and 12 slots dispose equiangularly about the central aperture, for receiving stator windings. However, in the present stator lamination 30, the labyrinthine passageways are formed through cooperation of intermediate apertures 200 located between the central aperture and the outer periphery 122 of each stator lamination 30. When assembled in a lamination stack, in accordance with the configuration illustrated in FIG. 4 above, the present laminations 30 cooperate to form labyrinthine passageways that travel axially and circumferentially as illustrated in FIG. 4, but wholly internal to the stator lamination stack. That is, the fluid pathway is defined by the cooperation of intermediate apertures 200 of adjacent stator laminations 30, thus fluid travels through the stator lamination stack radially inboard of the outer periphery 122 of each stator lamination 30. It is worth noting that the use of intermediate apertures 200 to form the labyrinthine passageways for the stator lamination stack, in the case of frameless electrical devices, can be extended to the stator lamination patterns illustrated in FIGS. 5, 7, 11, 12, 13, 14, 15a, 15b, among a host of other possible designs.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims. For example, although the foregoing discussion focuses on electric motors and generators, the present invention affords benefits to a number of applications involving lamination stack and the cooling of such.

What is claimed is:

1. A lamination for a lamination stack disposable in a frame, comprising:
a central aperture sized to receive a rotor;
a plurality of slots disposed circumferentially and about the central aperture for receiving a plurality of windings; and
an outer periphery defining a lamination cross-section and having at least one recessed section extending longitudinally between the ends of the lamination, wherein the at least one recessed section is configured to cooperate with a recessed section of an adjacent lamination of the lamination stack and with the frame to form a labyrinthine passageway extending along peripheral surfaces of the lamination stack.

2. The lamination as recited in claim 1, wherein the plurality of slots are arranged at equiangular positions with respect to one another.

3. The lamination as recited in claim 1, wherein the passageway is a labyrinthine passageway.

4. The lamination as recited in claim 1, wherein the at least one recessed section extends along the outer periphery from a first angular position corresponding to a first slot and a second angular position corresponding to a second slot nonadjacent to the first slot.

5. The lamination as recited in claim 1, wherein the lamination cross-section is asymmetric.

6. The lamination as recited in claim 1, wherein the passageway has an L-shaped cross-section.

7. An electric machine, comprising:
an enclosure comprising first and second end portions and a frame disposed between the end portions;
a rotor; and
a stator core comprising a plurality of stator laminations disposed in the frame, wherein the plurality of stator laminations cooperate to form a central aperture configured to receive the rotor, a plurality of slots disposed circumferentially about the central aperture and configured to receive a plurality of stator windings, and at least one recessed section cooperative with the frame to form a closed passageway for routing fluid along perimetric surfaces of the stator core.

8. The electric machine as recited in claim 7, wherein the stator laminations are substantially identical to one another.

9. The electric machine as recited in claim 8, wherein a first lamination of the plurality of substantially identical laminations is at a first angular orientation with respect to the frame and a second lamination of the substantially identical laminations is at second angular orientation with respect to the frame.

10. The electric machine as recited in claim 7, wherein the stator core comprises a plurality of recessed sections that each cooperate with the frame to form a plurality of closed passageways for routing fluid along perimetric surfaces of the core.

11. The electric machine as recited in claim 7, wherein the stator core has a generally circular cross-section.

12. The electric machine as recited in claim 7, wherein the frame comprises tabbed portions disposed on an inner surface of the frame and extending radially inward.

13. The electric machine as recited in claim 7, wherein each lamination of the plurality of laminations has an asymmetric lamination cross-section.

14. The electric machine as recited in claim 7, wherein a first lamination of the plurality of laminations is oriented at a first orientation in the stator core and a second lamination is oriented in mirror-image orientation with respect to the first orientation.

15. The electric machine as recited in claim 7, comprising a cooling unit configured to circulate fluid through the closed passageway.

16. A method of manufacturing a lamination stack disposable in a frame, comprising:
providing a plurality of laminations, each lamination having a central aperture sized to receive a rotor, a plurality of slots disposed circumferentially and about the central aperture for receiving a plurality of windings, and an outer periphery defining a lamination cross-section and having at least one radially recessed section extending longitudinally between the ends of the lamination, wherein the at least one radially recessed section of each lamination is configured to cooperate with a recessed section of an adjacent lamination of the lamination stack and the frame to form a labyrinthine passageway extending along perimetric surfaces of the lamination stack.

17. The method as recited in claim 16, wherein providing comprises fabricating the plurality of laminations.

18. The method as recited in claim 17, wherein fabricating comprises stamping the plurality of laminations from metal sheets.

19. The method as recited in claim 16, comprising providing the plurality of laminations such that the laminations are substantially identical to one another.

20. The method as recited in claim 19, comprising providing the plurality of laminations such that all laminations of the lamination stack are identical to one another.

21. A method of manufacturing an electric machine, comprising:
providing a plurality of laminations, each lamination having a central aperture sized to receive a rotor, a plurality of slots disposed circumferentially about the central aperture, and at least one radially recessed portion extending along an outer periphery of the lamination and longitudinally between the ends of the lamination;
arranging the plurality of laminations with respect one another to form a lamination stack, such that the at least one recessed portions of adjacent laminations cooperate to form a channel extending along perimetric surfaces of the lamination stack; and
disposing the lamination stack in a frame of motor such that the frame and the channel cooperate to form a closed passageway for routing fluid therethrough.

22. The method as recited in claim 21, wherein arranging comprises orientating a first lamination of plurality of laminations at a first angular orientation in the lamination stack and a second lamination of the plurality of laminating at second angular orientation that is a mirror-image orientation of the first orientation.

23. The method as recited in claim 21, wherein arranging comprises orientating a first lamination of the plurality of laminations at a first angular orientation in the lamination stack and of the plurality of laminations at second angular orientation stack and a second lamination rotated less than 180 degrees with respect to the first orientation.

24. An electric machine, comprising:
a frame;
a rotor; and
a core disposable in the frame and comprising a plurality of laminations, wherein the plurality of laminations cooperate to form a central aperture configured to receive the rotor and are cooperative with the frame to form at least one closed passageway for rotating fluid along peripheral surfaces of the core.

25. The electric machine as recited in claim 24, wherein the plurality of laminations comprise a first lamination having a first cross-section profile and a second lamination having a second cross-section profile different from the first profile.

26. The electric machine as recited in claim 24, wherein the at least one passageway is at least partially defined by at least one protrusion extending from a peripheral surface of the lamination.

27. The electric machine recited in claim 24, wherein the passageway has a labyrinthine cross-sectional profile.

28. The electric machine as recited in claim 24, wherein the frame has a smooth inner peripheral surface.

29. The electric machine as recited in claim 24, where the inner surface of the frame has no recessed portions.

30. A lamination for a lamination stack, comprising:
a central aperture sized to receive a rotor;
a plurality of slots disposed circumferentially about the central aperture for receiving a plurality of windings;
an outer periphery defining a lamination cross-section having an intermediate aperture extending through the lamination and being disposed between the plurality of slots and the outer periphery, wherein the intermediate aperture is configured to cooperate with an intermediate aperture of an adjacent lamination of the lamination stack to form a labyrinthine passageway extending axially through the lamination stack.

31. A lamination as recited in claim 30, comprising at least two intermediate apertures.

32. The lamination as recited in claim 30, wherein the cross-section is generally circular.

33. An electric machine, comprising:
a rotor; and
a stator core comprising a plurality of stator laminations, wherein the plurality of stator laminations cooperate to form a central aperture configured to receive the rotor, a plurality of slots disposed circumferentially about the central aperture and configured to receive a plurality of stator windings, and at least one intermediate aperture disposed between the plurality of slots and an outer periphery of the stator core, wherein the intermediate aperture is configured to allow a fluid to flow axially through the stator core, wherein the intermediate aperture defines a labyrinthine passageway for the flow of fluid.

34. The electric machine as recited in claim 33, wherein the stator laminations are substantially identical to one another.

35. The electric machine as recited in claim 34, wherein a first lamination of the plurality of substantially identical laminations is at a first angular orientation in the stator core and a second lamination of the substantially identical stator laminations is at a second angular orientation within the stator core.

36. The electric machine as recited in claim 33, wherein a first lamination of the plurality of laminations has a first cross-section and a second lamination of the plurality of laminations has a second cross-section different than the first cross-section.

37. The electric machine as recited in claim 33, wherein the stator core comprises a plurality of internal apertures extending axially through the core and independent of one another.

38. The electric machine as recited in claim 33, wherein each lamination of the plurality of laminations has an asymmetric lamination cross-section.

39. The electric machine as recited in claim 33, comprising a cooling unit configured to circulate cooling fluid through the intermediate aperture.
